(19) United States
(12) Patent Application Publication
(10) Pub. No.: US 2011/0065574 A1
(43) Pub. Date: Mar. 17, 2011

(54) IMAGE DECOLORING APPARATUS, IMAGE DECOLORING METHOD, AND SHEET TRANSFER APPARATUS

(75) Inventors: Hiroyuki TAGUCHI, Shizuoka-ken (JP); Isao YAHATA, Shizuoka-ken (JP); Takahiro KAWAGUCHI, Shizuoka-ken (JP); Ken IGUCHI, Shizuoka-ken (JP); Hiroyuki TSUCHIHASHI, Shizuoka-ken (JP); Hiroyuki TAKI, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 12/881,139

(22) Filed: Sep. 13, 2010

Related U.S. Application Data
(60) Provisional application No. 61/242,728, filed on Sep. 15, 2009.
(60) Provisional application No. 61/314,099, filed on Mar. 15, 2010.

(51) Int. Cl. B41M 5/26; B65H 5/00; B65H 7/02

(52) U.S. Cl. 503/201; 271/3.14

(57) ABSTRACT

The present invention provides an image decoloring apparatus including a plurality of, at least three, sheet load portions, each of the portions being able to be loaded with a sheet, an decoloring portion which performs decoloring an image on a sheet formed with the decolorable colorant, a first sheet transfer portion which transfers the sheet loaded in each of the plurality of sheet load portions to the decoloring portion, and a second sheet transfer portion which transfers the sheet after the decoloring is performed thereto by the decoloring portion to each of the plurality of sheet load portions.

### CROSS-REFERENCE TO RELATED APPLICATIONS

This application is based upon and claims the benefit of priority from: U.S. provisional application 61/242,728, filed on Sep. 15, 2009; and U.S. provisional application 61/314,099, filed on Mar. 15, 2010; the entire contents all of which are incorporated herein by reference.

### FIELD

Embodiments described herein relate generally to an image decoloring apparatus which performs the decoloring an image on a sheet formed with the decolorable colorant.

### BACKGROUND

Image decoloring apparatuses are conventionally known which perform the decoloring an image on a sheet formed with the decolorable colorant.

In such conventional image decoloring apparatuses, a sheet load portion for loading sheets to be subjected to decoloring is provided separately from a sheet load portion for loading the sheets after the decoloring is performed thereto.

In general, the sheet load portion for loading the sheets to be subjected to the decoloring and the sheet load portion for loading the sheets after the decoloring is performed thereto need to have the abilities to load substantially the same amount of sheet. This presents the problem in that large space is required for accommodating the sheets to cause difficulty in reducing the size of the image decoloring apparatus as a whole.

### DESCRIPTION OF THE DRAWINGS

FIG. 1 is a front view showing the outer appearance of an image decoloring apparatus E according to Embodiment 1.

FIG. 2 is a longitudinal section view showing the internal configuration of the image decoloring apparatus E.

FIG. 3 is a functional block diagram for describing various functions provided by the image decoloring apparatus E.

FIG. 4 is a flow chart for describing the flow of processing in the image decoloring apparatus.

FIG. 5 is a diagram showing how sheet transfer is performed toward an decoloring portion 503 from a sheet load portion 201 which accommodates sheets to be subjected to decoloring.

FIG. 6 is a diagram showing how the decoloring of a sheet is performed by the decoloring portion 503.

FIG. 7 is a diagram showing how the sheet is transferred to a sheet load portion 204 having empty space.

FIG. 8 is a diagram for describing the internal configuration of an image decoloring apparatus E1 according to Embodiment 2.

FIG. 9 is a diagram for describing drive control of a sheet load tray in Embodiment 2.

FIG. 10 is a diagram for describing the drive control of the sheet load tray in Embodiment 2.

FIG. 11 is a diagram for describing the drive control of the sheet load tray in Embodiment 2.

FIG. 12 is a diagram for describing the drive control of the sheet load tray in Embodiment 2.

FIG. 13 is a diagram showing an image decoloring apparatus E2 which is a modification of the configuration shown in FIG. 8.

### DETAILED DESCRIPTION

### Embodiment 1

In general, according to embodiments, an image decoloring apparatus has a plurality of, at least three, sheet load portions, an decoloring portion, a first sheet transfer portion, and a second sheet transfer portion.

Each of the plurality of, at least three, sheet load portions can be loaded with sheets.

The decoloring portion performs the decoloring of decoloring the color of an decolorable colorant to the sheet on which an image is formed by the decolorable colorant.

The first sheet transfer portion transfers the sheets loaded in each of the plurality of sheet load portions to the decoloring portion.

The second sheet transfer portion transfers the sheets after the decoloring is performed thereto by the decoloring portion to each of the plurality of sheet load portions.

Embodiment 1 will hereinafter be described with reference to the drawings.

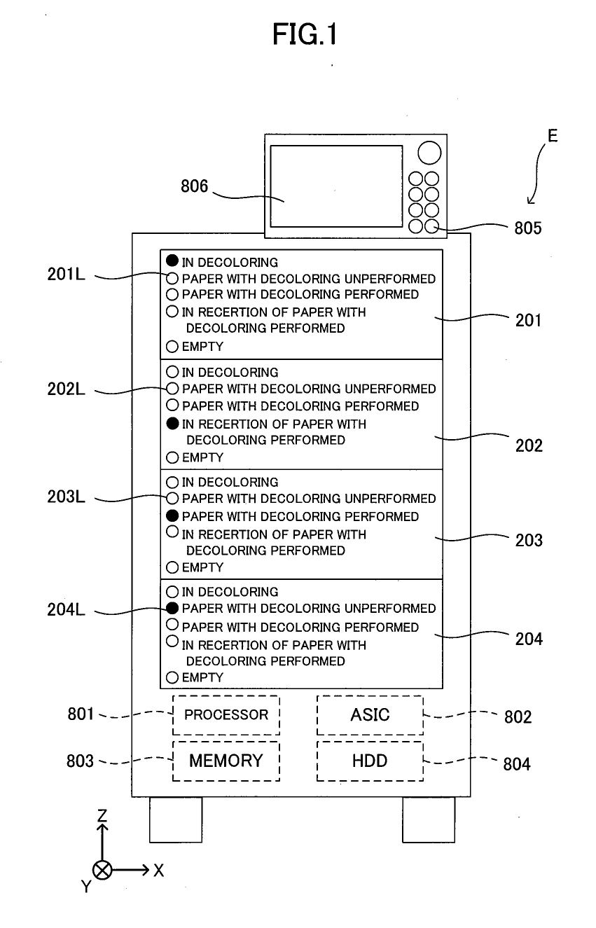

FIG. 1 is a front view showing the outer appearance of an image decoloring apparatus E according to Embodiment 1.

The image decoloring apparatus E performs the decoloring an image on a sheet formed with the “decolorable colorant” such as a so-called decolorable toner and a decolorable ink.

As shown in FIG. 1, the image decoloring apparatus E includes four sheet load portions 201 to 204, state display portions 201L to 204L, a processor 801, an ASIC (Application Specific Integrated Circuit) 802, a memory 803, an HDD (Hard Disk Drive) 804, an operation input portion 805, and a display 806.

The operation input portion 805 can be provided by, for example, a keyboard, a mouse, a touch panel, a touchpad, a graphics tablet, dedicated buttons or the like.

The display 806 can be provided by, for example, electronic paper, an LCD (Liquid Crystal Display), an EL (Electronic Luminescence) device, a PDP (Plasma Display Panel), a CRT (Cathode Ray Tube) or the like.

Alternatively, a so-called touch panel display may be used to realize the functions of the operation input portion 805 and the display 806.

In the image decoloring apparatus E, the processor 801 is responsible for performing various types of processing in the image decoloring apparatus E and is also responsible for realizing various functions by executing programs stored in the memory 803, the HDD 804 and the like. It goes without saying that the processor 801 may be realized by a CPU (Central Processing Unit) or an MPU (Micro Processing Unit) which can perform equivalent computation. The HDD 804 may be replaced with a storage apparatus such as a flash memory, for example.

The memory 803 can be provided by, for example a RAM (Random Access Memory), a ROM (Read Only Memory), a DRAM (Dynamic Random Access Memory), a SRAM (Static Random Access Memory), a VRAM (Video RAM), a flash memory or the like, and is responsible for storing various types of information and programs for use in the image decoloring apparatus E.

The state display portions 201L to 204L have LED lamps or organic EL lamps, for example, and the turn-on of the lamp is controlled by, for example, the processor 801 or the ASIC 802. In FIG. 1, the lamp indicated by a black circle represents turn-on, while the lamp indicated by a white circle represents turn-off.

The operation input portion 805 can be provided by, for example, a keyboard, a mouse, a touch panel, a touchpad, a graphics tablet, dedicated buttons or the like.

The display 806 can be provided by, for example, electronic paper, an LCD (Liquid Crystal Display), an EL (Electronic Luminescence) device, a PDP (Plasma Display Panel), a CRT (Cathode Ray Tube) or the like.

Alternatively, a so-called touch panel display may be used to realize the functions of the operation input portion 805 and the display 806.

Next, the internal configuration of the image decoloring apparatus E will be described in detail.

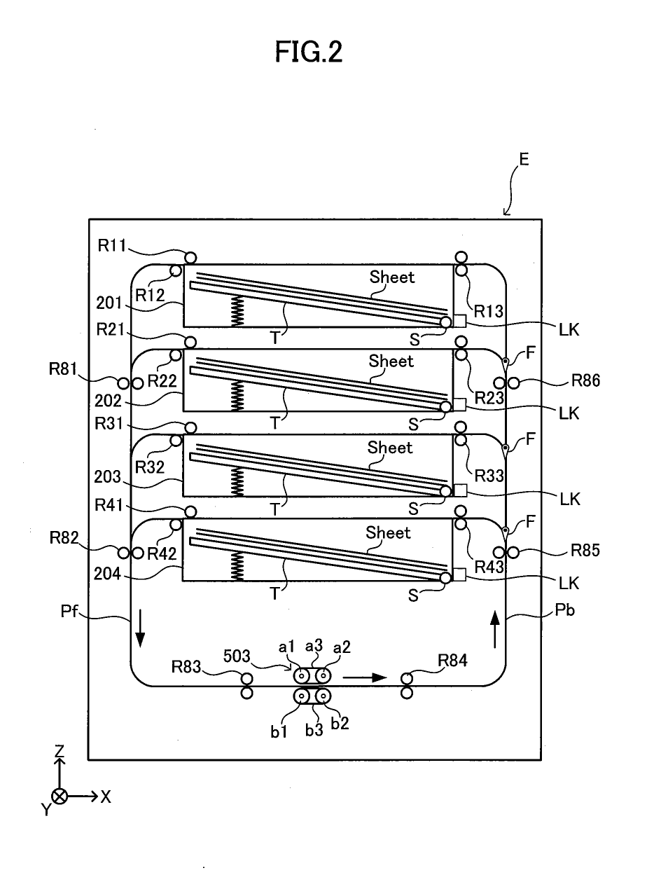

FIG. 2 is a longitudinal section view showing the internal configuration of the image decoloring apparatus E.

The image decoloring apparatus E includes, for example, the sheet load portions 201 to 204 for loading and accommodating the sheets to be subjected to the decoloring on which images are formed or the sheets after the decoloring is performed thereto, an decoloring portion 503 for thermally decoloring the color of the image formed on the sheet by the decolorable colorant, a transfer path Pf for guiding the sheet loaded in each of the plurality of sheet load portions 201 to 204 to the decoloring portion 503, a transfer path Pb for guiding the sheet after the decoloring is performed thereto by the decoloring portion 503 to each of the plurality of sheet load portions 201 to 204, transfer rollers R81 to R86 for transferring the sheet on the transfer paths Pf and Pb and the like, supply rollers R11, R12, R21, R22, R31, R32, R41, and R42 for supplying the sheets from the sheet load portions 201 to 204 to the transfer path, discharge rollers R13 to R43 for discharging the sheets from the transfer path to the sheet load portions 201 to 204, flappers F for controlling the sheet transfer direction, lock mechanisms LK, and sensors S.

The transfer path Pf, the sheet supply rollers R11, R12, R21, R22, R31, R32, R41, and R42, the flappers F, and the transfer rollers R81, R82, and R83 correspond to a “first sheet transfer portion.” The “first sheet transfer portion” transfers the sheet loaded in each of the plurality of sheet load portions 201 to 204 to the decoloring portion 503.

The transfer path Pb, the discharge rollers R13 to R43, the flappers F, and the transfer rollers R84, R85, and R86 correspond to a “second sheet transfer portion.” The “second sheet transfer portion” transfers the sheet after the decoloring is performed thereto by the decoloring portion 503 to each of the plurality of sheet load portions 201 to 204.

The plurality of sheet load portions 201 to 204 are arranged in a vertical direction (a Z-axis direction in FIG. 2).

The “first sheet transfer portion” is provided on one end side (the left side in FIG. 2) of each of the plurality of sheet load portions 201 to 204 in a direction orthogonal to the vertical direction (the Z-axis direction in FIG. 2). The second sheet transfer portion is provided on the other end side (the right side in FIG. 2) of each of the plurality of sheet load portions 201 to 204 in the direction orthogonal to the vertical direction.

The decoloring portion 503 is placed below the plurality of sheet load portions 201 to 204. This placement of the decoloring portion 503 can locate each of the sheet load portions in an upper portion of the apparatus, so that ease of operation can be enhanced for insertion and removal of the sheets into and from each of the sheet load portions.

In Embodiment 1, the plurality of sheet load portions 201 to 204 can be formed such that the same numbers of sheets can be loaded therein. With the same numbers of sheets which can be loaded in the plurality of sheet load portions 201 to 204 in this manner, a certain number of sheets accommodated by one of the sheet load portions can be accommodated by another one of the sheet load portions without fail. Thus, if a user wants to decolor the colors of an image on the sheets accommodated by one of the plurality of sheet load portions 201 to 204 and place these sheets into another one of the sheet load portions, the user does not need to consider the number of sheets which can be accommodated by the receiving sheet load portion.

It goes without saying that the present invention is not limited thereto and different numbers of sheets can be accommodated by the plurality of sheet load portions 201 to 204.

Each of the sheet load portions 201 to 204 can be pulled out in a Y-axis direction in FIG. 2. Each of the sheet load portions 201 to 204 is formed to be lockable by the lock mechanism LK such that the portions 201 to 204 cannot be pulled out. The locking or unlocking by the lock mechanism LK is controlled through signals from the processor 801.

A tray T is placed for loading the sheets in each of the sheet load portions 201 to 204. The tray T is pivotally supported with one end thereof set as a pivot, and a lower surface of the tray T is urged upward. The sensor S is provided, for example near the pivot, and senses the pivot amount of the tray T. The processor 801 can estimate the number of sheets loaded on the tray T based on the sensing result of the sensor S.

While the case where the sensor S senses the pivot amount of the tray T is herein shown, the present invention is not limited thereto. For example, an optical transmission-type sensor or reflection-type sensor may be used for sensing the presence or absence of sheets loaded on the tray T or the number of loaded sheets.

The decoloring portion 503 includes a roller a1, a roller a2, and a belt a3 wound around these rollers, and the belt a3 rotates in association with the rotation of the rollers. At least one of the roller a1 and the roller a2 is driven to rotate by the processor 801. At least one of the roller a1 and the roller a2 is heated by a heater controlled by the processor 801.

The decoloring portion 503 formed as described above heats the sheet sandwiched between and transferred by the belt a3, a belt b3, the transfer roller R83, the transfer roller R84 and the like while transferring the sheet, thereby decoloring the color of the decolorable colorant formed on the sheet.

The processor 801 controls the control parameters of the decoloring performed by the decoloring portion 503, the speed of the sheet transferred by the sheet transfer portion and the like, based on acquired print state information.

The state display portions 201L to 204L display information about the sheet load statuses in the plurality of sheet load portions 201 to 204, respectively, based on load information acquired by a load information acquiring portion 101.

Specifically, each of the state display portions 201L to 204L selectively displays one of the following five states:

(1) “in erasure” which indicates that the sheet is being supplied from within the associated sheet load portion to the decoloring portion 503;

(2) “paper with erasure unperformed” which indicates that the sheet to be subjected to decoloring by the decoloring portion 503 is accommodated;

(3) “paper with erasure performed” which indicates that the sheet after decoloring is performed thereto by the decoloring portion 503 is accommodated;

(4) “in reception of paper with erasure performed” which indicates that the sheet after decoloring is performed thereto by the decoloring portion 503 is being received; and

(5) “empty” which indicates that no sheets are accommodated.

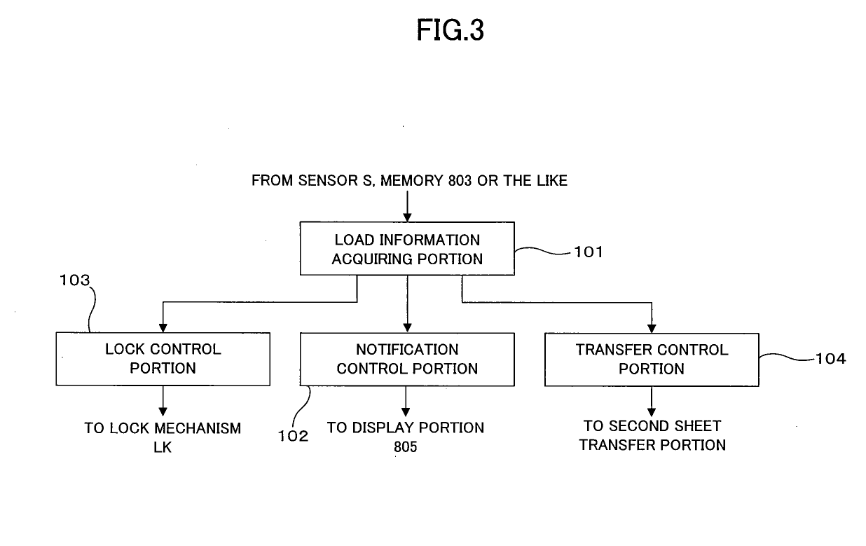

FIG. 3 is a functional block diagram for describing various functions provided by the image decoloring apparatus E.

As shown in FIG. 3, the image decoloring apparatus E has the load information acquiring portion 101, a notification control portion 102, a lock control portion 103, and a transfer control portion 104.

The load information acquiring portion 101 acquires load information about the sheet load status in each of the plurality of sheet load portions 201 to 204.

The “load information” in this case includes, for example, the number of loaded sheets in each of the sheet load portions 201 to 204 sensed by the sensor S.

The notification control portion 102 causes the display portion 806 (notifying portion) to show on a screen that one of the plurality of sheet load portions 201 to 204 should be emptied so as to make a notification to a user if it is determined on the basis of the load information acquired by the load information acquiring portion 101 that sheets are loaded in all of the plurality of sheet load portions 201 to 204. Naturally, the notification by the notification control portion 102 may be performed by a sound through a speaker or the like generally included in the image decoloring apparatus E.

The lock control portion 103 causes the lock mechanism LK to lock one (s) of the plurality of sheet load portions 201 to 204 such that the locked sheet load portion (s) cannot be pulled out, on the basis of the load information acquired by the load information acquiring portion 101. For example, the locking can be performed by the lock mechanism LK in order to prevent the user from opening the sheet load portion which is loaded with a batch of sheets in the process of decoloring or the sheet load portion into which the sheet after the decoloring is performed thereto is being carried.

The transfer control portion 104 causes the second sheet transfer portion to transfer the sheet to one of the plurality of sheet load portions 201 to 204 that is loaded with no sheets, on the basis of the load information acquired by the load information acquiring portion 101.

Such a configuration allows the sheet load portions to be used for both of (1) the load of the sheets before the decoloring and of (2) the load of the sheets after the decoloring. Thus, a large amount of sheet can be loaded while the space-saving apparatus configuration is used.

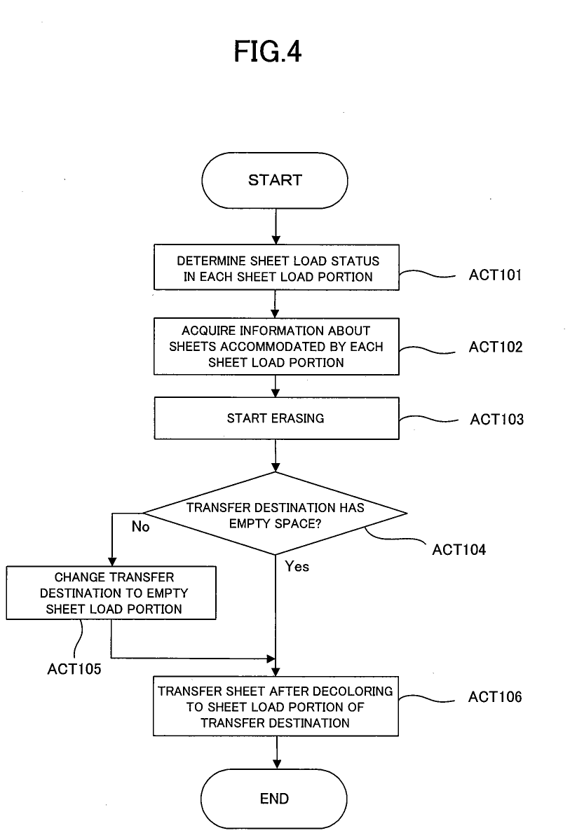

FIG. 4 is a flow chart for describing the flow of processing in the image decoloring apparatus.

The processor 801 determines the sheet load status in each of the sheet load portions 201 to 204 based on the load information acquired by the load information acquiring portion 101 (ACT 101).

The processor 101 acquires information about the sheets accommodated by each of the sheet load portions 201 to 204 stored in the memory 803 or the like through operation input or the like of the operation input portion 805, for example (ACT 102).

For example, the user can input and set whether or not the sheets loaded in each of the sheet load portions 201 to 204 are not subjected to decoloring yet through operation of the operation input portion 805. The processor 801 can acquire the input and set information.

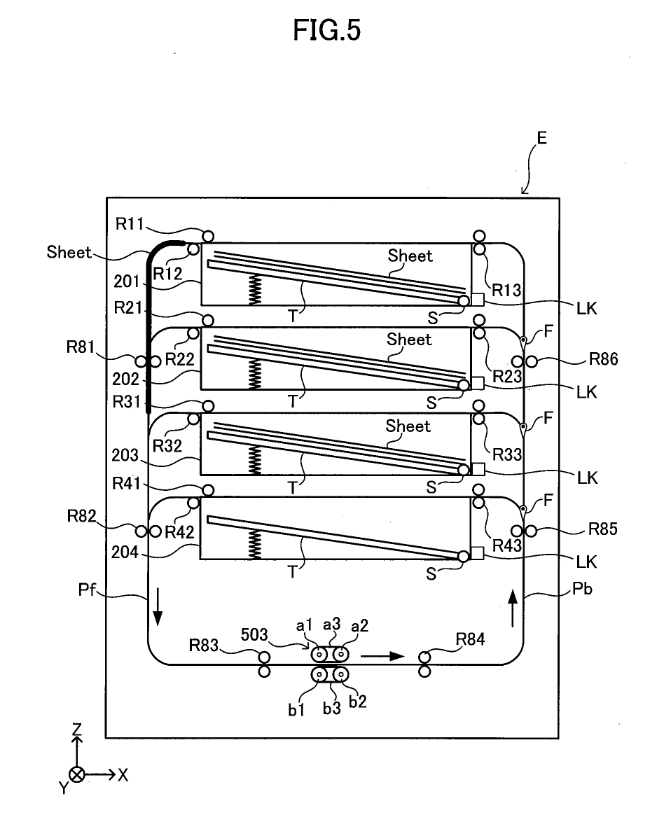

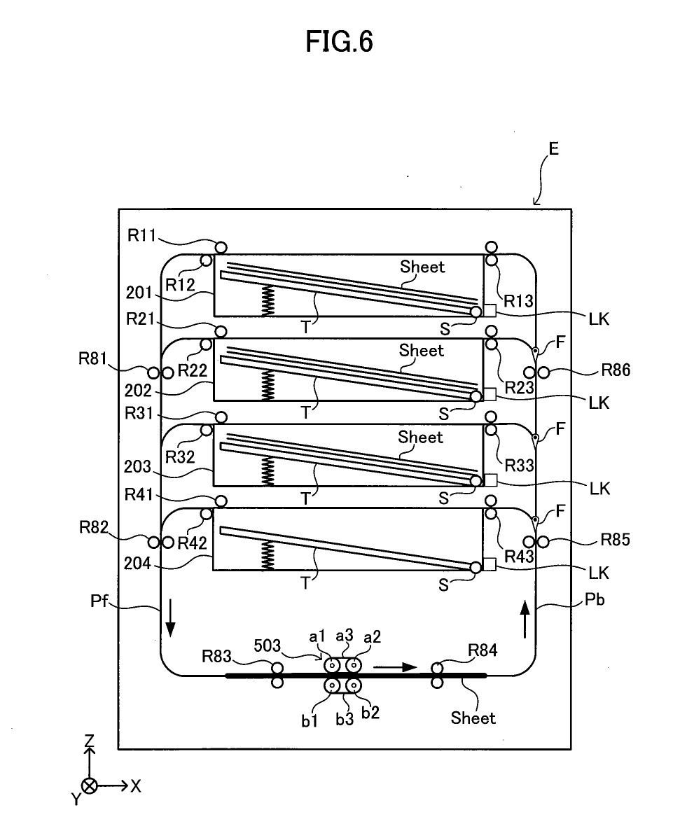

Next, the processor 801 causes the first sheet transfer portion, the decoloring portion 503, and the second sheet transfer portion to cooperate to start the decoloring of the sheets (ACT 103). FIG. 5 is a diagram showing how sheet transfer is performed toward the decoloring portion 503 from the sheet load portion 201 which accommodates the sheets to be subjected to decoloring. FIG. 6 is a diagram showing how the decoloring of the sheet is performed by the decoloring portion 503.

The processor 801 determines based on “load information” or the like whether or not the sheet load portion currently set to the transfer destination of the sheet after the decoloring has empty space (ACT 104). If the currently set sheet load portion has no empty space (No at ACT 104), then the processor 801 changes the setting such that another sheet load portion having empty space is specified as a sheet transfer destination (ACT 105).

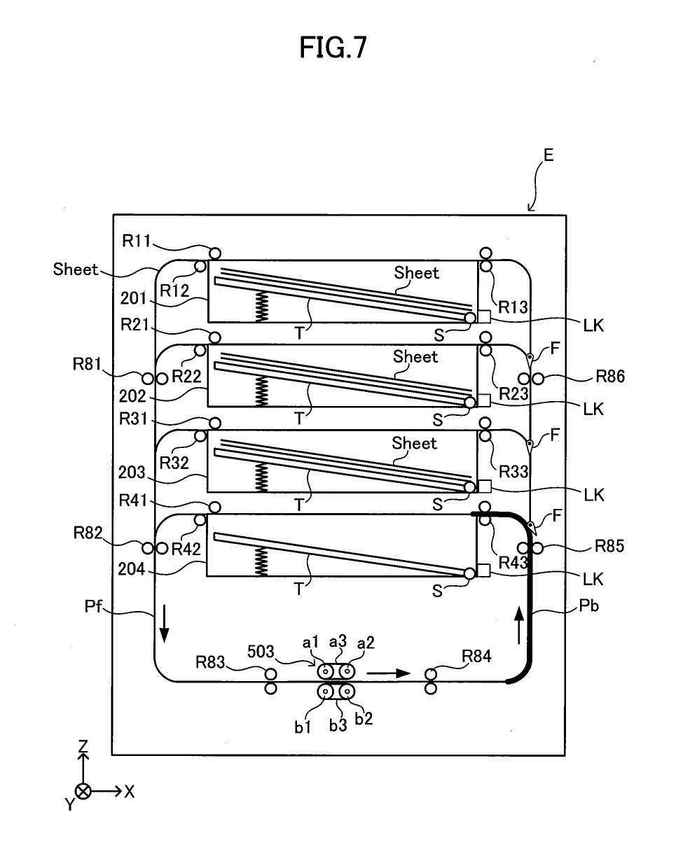

If the currently set sheet load portion has empty space (Yes at Act 104), then the processor 801 transfers the sheet after the decoloring to that sheet load portion (ACT 106). FIG. 7 is a diagram showing how the sheet is transferred to the sheet load portion 204 having empty space.

The processor 801 does not change the sheet load portion of the transfer destination until the processing is finished for all of the sheets accommodated by the sheet load portion in which the decoloring is started.

Then, the processor 801 assumes that the sheet load portion from which the sheet subjected to the decoloring is transferred is empty at present, and uses that sheet load portion as the next transfer destination of the sheet after decoloring.

In this case, in order to prevent the user from inadvertently loading sheets in the sheet load portion set to the next transfer destination, the processor 801 may control the lock mechanism LK such that that sheet load portion cannot be pulled out.

Each operation in the processing in the image decoloring apparatus described above is realized by the processor 801 executing the decoloring program stored in the memory 802.

In addition, the program for performing each operation described above in a computer constituting the image decoloring apparatus can be provided as the decoloring program. While Embodiment 1 shows the case where the program for realizing the functions implementing the invention is previously recorded in the storage area provided within the apparatus, the present invention is not limited thereto, and a similar program may be downloaded from a network to the apparatus, or a similar program may be stored in a computer-readable recording medium and be installed on the apparatus. Any form of the recording medium may be used as long as the recording medium can store the program and be read by a computer. Specifically, examples of the recording medium include an internal storage apparatus such as a ROM and a RAM internally implemented in a computer, a portable storage medium such as a CD-ROM, a flexible disk, a DVD disk, a magneto-optical disk, and an IC card, a database for holding a computer program, or another computer and its database, a transmission medium on a channel and the like. The functions obtained by previous installation or download may be realized through cooperation with an OS (Operating System) within the apparatus.

Part or all of the program may be an executable module provided dynamically.

It goes without saying that, in the above-mentioned embodiment, at least some of various types of the processing realized by the processor executing the program may performed by the ASIC 802 in circuitry.

### Embodiment 2

Next, Embodiment 2 will be described.

In Embodiment 2, portions having the same functions as those of the portions already described in Embodiment 1 are designated with the same reference numerals, and description thereof is omitted.

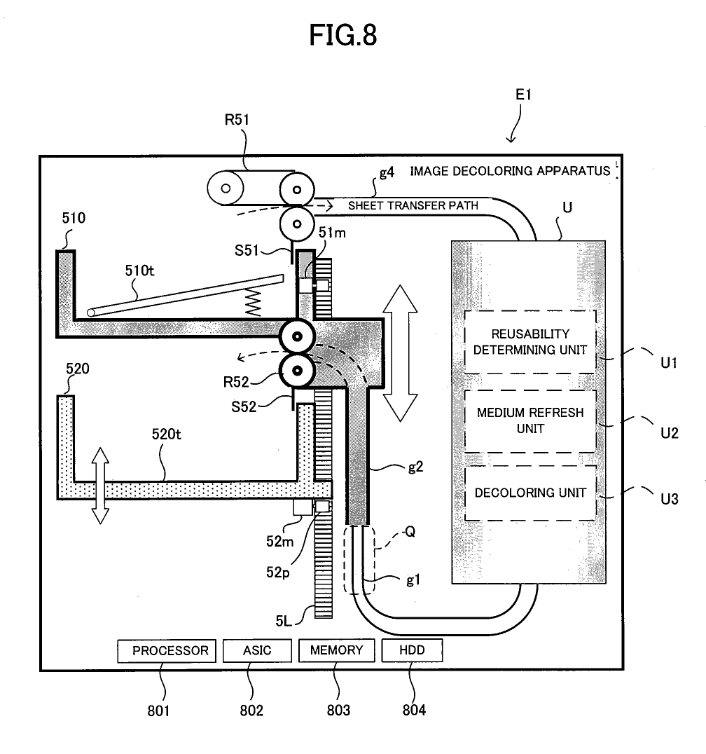

FIG. 8 is a diagram for describing the internal configuration of an image decoloring apparatus E1 according to Embodiment 2. The image decoloring apparatus E1 includes a sheet transfer apparatus.

The image decoloring apparatus E1 includes a first sheet load portion 510, a supply roller R51, a second sheet load portion 520, a discharge roller R52 (sheet discharge portion), a first sheet transfer path g1, a second sheet transfer path g2, a sheet transfer path g4, a sheet surface sensor S52, an decoloring unit U, and a rack 5L.

The first sheet load portion 510 is loaded with sheets before decoloring on a first sheet load surface 510t and is movable in a vertical direction in FIG. 8. The first sheet load portion 510 includes a motor 51m and a pinion 51p attached to a drive shaft of the motor 51m.

The supply roller R51 (sheet supply portion) supplies the sheets loaded on the first sheet load surface 510t toward the decoloring unit U (predetermined supply destination) through the sheet transfer path g4.

The decoloring unit U includes a reusability determining unit U1 which judges the state of an image on the sheet or the state of waves of the sheet by using a line sensor or a thickness sensor to determine whether or not the sheet is reusable, a medium refresh unit U2 which removes dust or the like on the sheet to be subjected to decoloring, and an decoloring unit U3 which thermally decolors the color of the image of an decolorable colorant formed on the transferred sheet.

The sheet supplied to the decoloring unit U through the sheet transfer path g4 is then discharged from the decoloring unit U toward the first sheet transfer path g1 in the state after the decoloring is performed to the sheet.

In the second sheet load portion 520, the sheet subjected to the decoloring and discharged from within the apparatus is loaded on a second load surface 520t. At least part of the second load surface 520t is located below the first sheet load surface 510t of the first sheet load portion 510. The second sheet load portion 520 is movable in the vertical direction in FIG. 8. The second sheet load portion 520 includes a motor 52m and a pinion 52p attached to a drive shaft of the motor 52m.

The motor 51m in the first sheet load portion 510 and the motor 52m in the second sheet load portion 520 are controlled to be driven by a processor 801.

Each of the pinion 51p in the first sheet load portion 510 and the pinion 52p in the second sheet load portion 520 engages with the rack 5L (which extends in the vertical direction in FIG. 8), so that the first sheet load portion 510 and the second sheet load portion 520 can be individually controlled to be driven on the basis of control signals from the processor 801 to the motors 51m and 52m.

The discharge roller R52 (sheet discharge portion) moves together with the first sheet load portion 510 in the vertical direction and discharges the sheet transferred from the decoloring unit U through the sheet transfer path g4, the first sheet transfer path g1, the second sheet transfer path g2, and a sheet transfer path g3, onto the second sheet load surface 520t of the second sheet load portion 520.

The first sheet transfer path g1 is provided fixedly to the apparatus body, extends from the decoloring unit U toward the discharge roller R52, and has a straight portion Q which extends in a direction (vertical direction) in parallel with the moving direction of the first sheet load portion 510.

The second sheet transfer path g2 moves together with the first sheet transfer path g1. An upstream end portion of the path g2 in the sheet transfer direction surrounds the outer periphery of the straight portion Q, and a downstream end portion of the path g2 in the sheet transfer direction extends toward the discharge roller R52.

In this manner, the second sheet transfer path g2 connected to the sheet discharge port and the fixed first sheet transfer path g1 are placed in a nested arrangement to allow the sheet transfer even while the first sheet load portion 510 is moved vertically.

Since the first transfer path g1 is inserted into the second transfer path g2, the sheet transferred in the first transfer path g1 is not snagged when the sheet is moved into the second transfer path g2.

The second sheet load surface 520t is located below the first sheet load surface 510t.

If viewed in the vertical direction, the same range can be used for loading the sheets before decoloring and for loading the sheets after decoloring, which can contribute to space saving of the apparatus as a whole.

As the sheets loaded in the first sheet load portion 510 are supplied to the decoloring unit U by the supply roller R51 (as the number of the supplied sheets is increased), the processor 801 (drive control portion) raises the first sheet load portion 510 and lowers the second sheet load portion 520.

The sheet surface sensor S52 is provided below the first sheet load portion 510 and senses the upper surface of a batch of sheets loaded on the second sheet load surface 520t. The sheet surface sensor S52 can be formed, for example, by using a mechanical sensor such as a switch or a reflection-type or transmission-type sensor.

The processor 801 (drive control portion) maintains the vertical interval between the first sheet load portion 510 and the second sheet load portion 520 at a predetermined interval based on the sense result of the sheet surface sensor S52.

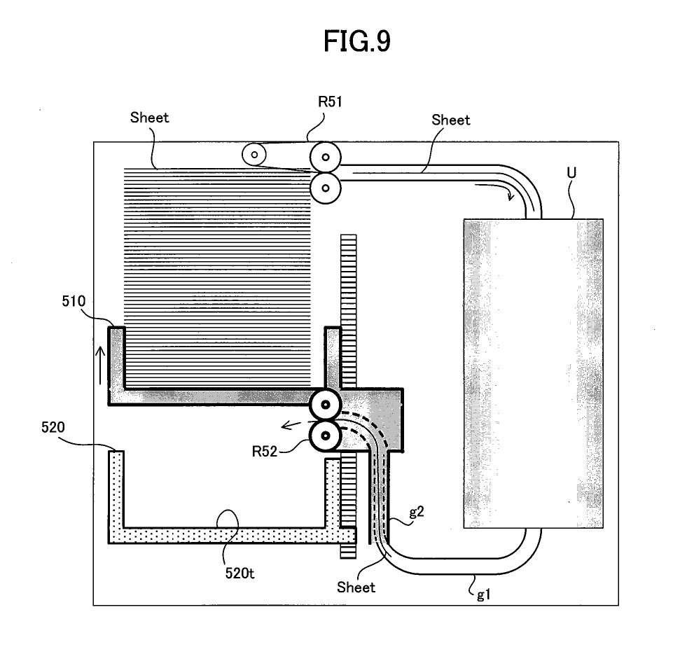

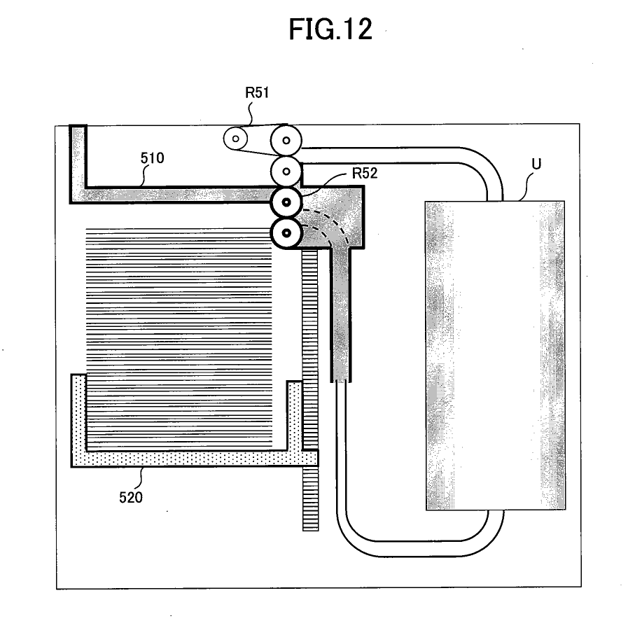

FIG. 9 to FIG. 12 are diagrams for describing drive control of a sheet load tray.

As shown in FIG. 9, from the state in which the sheets before decoloring are loaded in the first sheet load surface 510t, the sheet is supplied to the decoloring unit U by the supply roller R51 controlled to be driven by the processor 801.

The sheet, after the decoloring is performed thereto by the decoloring unit U, is then discharged sequentially onto the second sheet load surface 520t by the discharge roller R52.

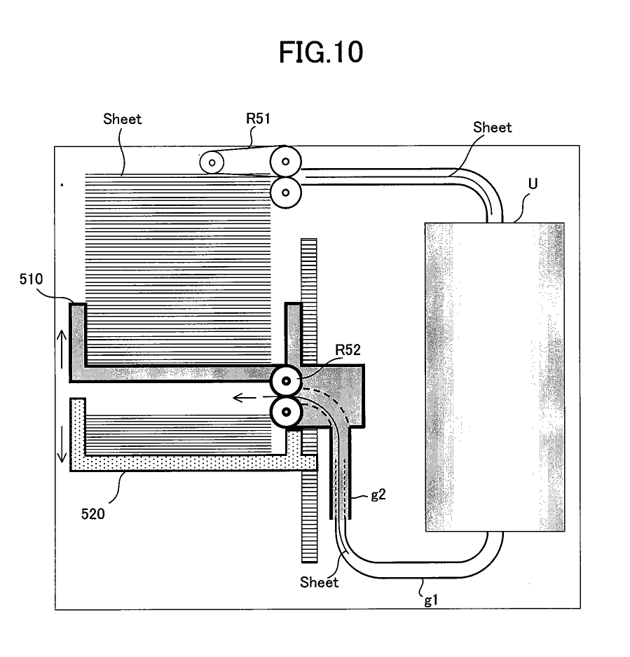

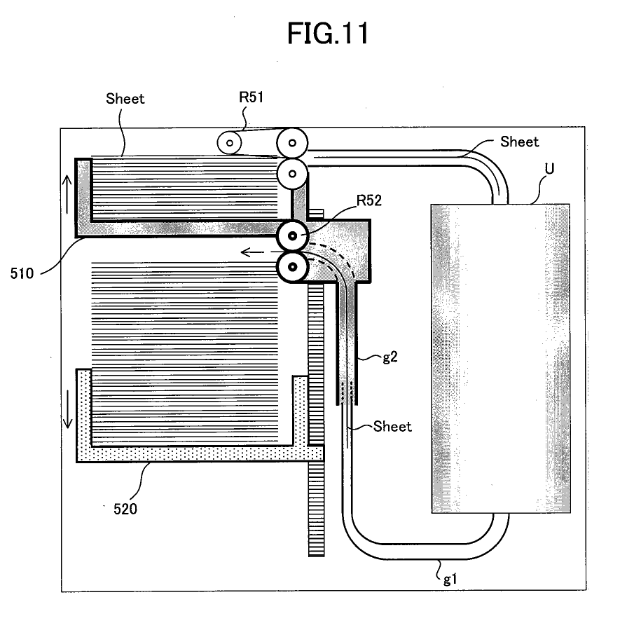

As the number of the sheets subjected to the decoloring by the decoloring unit U is increased, the processor 801 controls the drive of the motor 51m and the motor 52m to raise the first sheet load portion 510 and to lower the second sheet load portion 520 (FIG. 10 and FIG. 11).

The processor 801 causes the sheet surface sensor S52 to sense the upper surface of the sheets intermittently and maintains the upper surface of the batch of sheets loaded on the first sheet load surface 510t that is lowered due to the supply of the sheets to the decoloring unit U at a constant level relative to the supply roller R51 by moving the first sheet load portion 510 upward.

The processor 801 previously maintains a defined distance between the lower surface of the first sheet load portion 510 and the second sheet load portion 520 based on the sense result of the upper-surface sensor S52 such that the sheets discharged from the discharge roller R52 can be loaded.

The upper surface of the loaded sheets in the second sheet load portion 520 is raised due to the load of the sheets after the decoloring and the first sheet load portion 510 is raised due to the continuous supply of the sheets from the first sheet load portion 510 at the same time. The processor 801 can use the upper-surface sensor S52 to hold the interval between those sheet load portions constant.

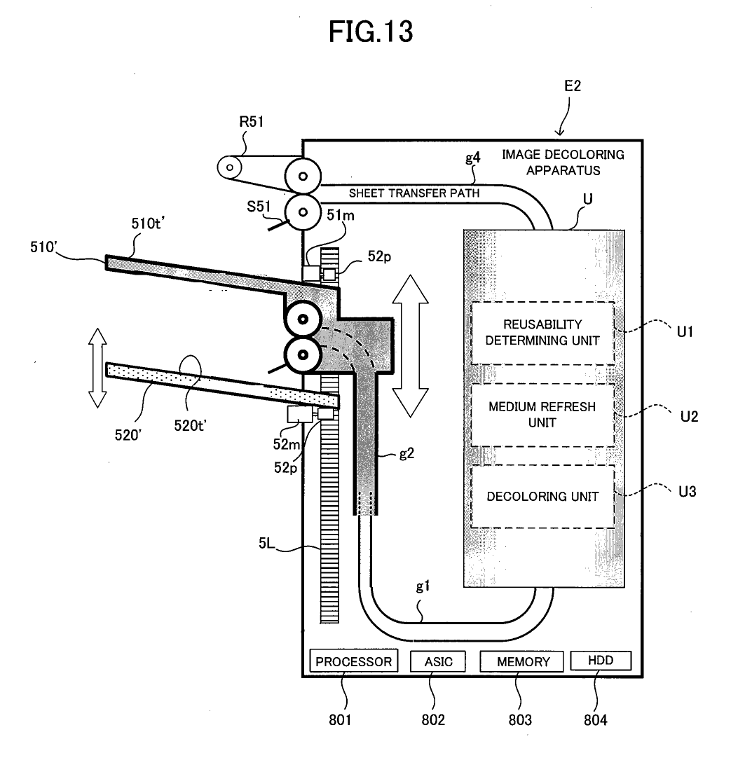

FIG. 13 is a diagram showing an image decoloring apparatus E2 which is a modification of the configuration shown in FIG. 8.

In an example shown in FIG. 13, both of a first sheet load portion 510′ corresponding to the first sheet load portion 510 and a second sheet load portion 520′ corresponding to the second sheet load portion 520 are formed to protrude from the apparatus.

Such a configuration in which the first sheet load portion 510′ and the second sheet load portion 520′ protrudes from the apparatus can reduce the size of the housing of the apparatus to contribute to space saving.

The configuration allows the space used for loading sheets before decoloring at the start of decoloring to be used for loading the sheets after the decoloring at the end of the decoloring.

As described above in detail, according to the techniques described in the present specification, the technique can be provided which contributes to a size reduction of the image decoloring apparatus which performs the decoloring of decoloring the color of the decolorable colorant to the sheet on which the image is formed by the decolorable colorant.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An image decoloring apparatus comprising:
a plurality of, at least three, sheet load portions, each of the portions being able to be loaded with a sheet;
an decoloring portion which performs decoloring an image on a sheet formed with the decolorable colorant;
a first sheet transfer portion which transfers the sheet loaded in each of the plurality of sheet load portions to the decoloring portion; and
a second sheet transfer portion which transfers the sheet after the decoloring is performed thereto by the decoloring portion to each of the plurality of sheet load portions.

2. The apparatus according to claim 1, wherein the plurality of sheet load portions are arranged in a vertical direction, and
wherein the first sheet transfer portion is provided on one end side of each of the plurality of sheet load portions in a direction orthogonal to the vertical direction, and the second sheet transfer portion is provided on the other end side of each of the plurality of sheet load portions in the direction orthogonal to the vertical direction.

3. The apparatus according to claim 1, wherein the plurality of sheet load portions can be loaded with substantially the same number of sheets.

4. The apparatus according to claim 1, further comprising:
a load information acquiring portion which acquires load information about a sheet load status in each of the plurality of sheet load portions;
a notifying portion which notifies a user of information; and
a notification control portion which causes the notifying portion to make a notification that one of the plurality of sheet load portions should be emptied if it is determined on the basis of the load information acquired by the load information acquiring portion that the sheets are loaded in all of the plurality of sheet load portions.

5. The apparatus according to claim 1, wherein the plurality of sheet load portions are arranged in a vertical direction, and
wherein the decoloring portion is located below the plurality of sheet load portions.

6. The apparatus according to claim 1, wherein each of the plurality of sheet load portions can be pulled out of the image decoloring apparatus,
the apparatus further comprising:
a lock mechanism which disables each of the plurality of sheet load portions from being pulled out;
a load information acquiring portion which acquires load information about a sheet load status in each of the plurality of sheet load portions; and
a lock control portion which causes the lock mechanism to perform locking such that one (s) of the plurality of sheet load portions cannot be pulled out on the basis of the load information acquired by the load information acquiring portion.

7. The apparatus according to claim 1, further comprising:
a load information acquiring portion which acquires load information about a sheet load status in each of the plurality of sheet load portions; and
a state display portion which displays information about the sheet load status in each of the plurality of sheet load portions based on the load information acquired by the load information acquiring portion.

8. The apparatus according to claim 1, further comprising:
a load information acquiring portion which acquires load information about a sheet load status in each of the plurality of sheet load portions; and
a transfer control portion which causes the second sheet transfer portion to transfer the sheet to one of the plurality of sheet load portions, the one of the sheet load portions being loaded with no sheet, on the basis of the load information acquired by the load information acquiring portion.

9. A method of decoloring in an image decoloring apparatus comprising a plurality of, at least three, sheet load portions, each of the portions being able to be loaded with a sheet, an decoloring portion which performs decoloring an image on a sheet formed with the decolorable colorant, a first sheet transfer portion which transfers the sheet loaded in each of the plurality of sheet load portions to the decoloring portion, and a second sheet transfer portion which transfers the sheet after the decoloring is performed thereto by the decoloring portion to each of the plurality of sheet load portions, the method comprising:
transferring the sheet in one of the plurality of sheet load portions to the decoloring portion by the first sheet transfer portion; and
transferring the sheet after the decoloring is performed thereto by the decoloring portion to one of the plurality of sheet load portions by the second sheet transfer portion, the one of the sheet load portions being other than the sheet transfer portion from which the sheet is transferred to the decoloring portion.

10. The method according to claim 9, further comprising:
acquiring load information about a sheet load status in each of the plurality of sheet load portions; and
displaying information about the sheet load status in each of the plurality of sheet load portions based on the acquired load information.

11. The method according to claim 10, further comprising:
determining, on the basis of the acquired load information, whether or not sheets are load in all of the plurality of sheet load portions; and
if it is determined that the sheets are loaded in all of the plurality of sheet load portions, making a notification that one of the plurality of sheet load portions should be emptied.

12. The method according to claim 9, further comprising:
acquiring load information about a sheet load status in each of the plurality of sheet load portions; and
causing the second sheet transfer portion to transfer the sheet to one of the plurality of sheet load portions, the one of the sheet load portions being loaded with no sheet, on the basis of the acquired load information.

13. A sheet transfer apparatus comprising:
a first sheet load portion which has a first sheet load surface on which a sheet is loaded, the first sheet load portion being movable in a vertical direction;
a sheet supply portion which supplies the sheet loaded on the first sheet load surface to a predetermined supply destination;
a second sheet load portion which has a second sheet load surface on which a sheet is loaded, at least part of the second sheet load surface being located below the sheet load surface of the first sheet load portion, the second sheet load portion being movable in the vertical direction; and
a sheet discharge portion which moves together with the first sheet load portion in the vertical direction and discharges the sheet transferred from the predetermined supply destination onto the second sheet load surface of the second sheet load portion.

14. The sheet transfer apparatus according to claim 13, further comprising a first sheet transfer path which extends from the predetermined supply destination toward the sheet discharge portion and has a straight portion extending in a direction in parallel with a moving direction of the first sheet load portion,
wherein the sheet discharge portion has a second sheet transfer path moving together with the first sheet transfer portion, an upstream end portion of the second sheet transfer path in a sheet transfer direction surrounds an outer periphery of the straight portion, and a downstream end portion of the second sheet transfer path in the sheet transfer direction extends toward a sheet discharge port in the sheet discharge portion.

15. The sheet transfer apparatus according to claim 13, wherein the second sheet load surface is located below the first sheet load surface.

16. The sheet transfer apparatus according to claim 13, further comprising a drive control portion which raises the first sheet load portion and lowers the second sheet load portion as sheets loaded in the first sheet load portion are supplied to the predetermined supply destination by the sheet supply portion.

17. The sheet transfer apparatus according to claim 16, further comprising a sheet surface sensor which is provided below the first sheet load portion and senses an upper surface of a batch of sheets located on the second sheet load surface,
wherein the drive control portion maintains a vertical interval between the first sheet load portion and the second sheet load portion at a predetermined interval based on a sense result of the sheet surface sensor.
